(19) United States
(12) Patent Application Publication
(10) Pub. No.: US 2007/0132539 A1
(43) Pub. Date: Jun. 14, 2007

(54) FUSIBLE SPIRAL CONDUCTOR FOR A FUSE COMPONENT WITH A PLASTIC SEAL

(75) Inventors: Ludger Richter, Lundingshausen (DE); Manfred Rupalla, Witten (DE); Peter Posnicker, Witten (DE); Uwe Roeder, Witten (DE)

Correspondence Address: BELL, BOYD & LLOYD LLP, P.O. BOX 1135, CHICAGO, IL, 60690, US

(73) Assignee: WICKMANN-WERKE GMBH, Witten (DE)

(21) Appl. No.: 11/421,978

(22) Filed: Jun. 2, 2006

(30) Foreign Application Priority Data
Jun. 2, 2005 (EP) EP05011930

(51) Int. Cl. H01H 61/00

(52) U.S. Cl. 337/14

(57) ABSTRACT

A fusible spiral conductor for a fuse component includes an electrically insulating or high resistance core, at least one fusible conductive wire wound around the core, and a temperature-resistant plastic material. The temperature-resistant plastic material applied to the core and arranged such that at least the surface regions of the core exposed between the fusible conductive wire are covered by the plastic material and the interstices defined between the wound fusible conductive wire and the surface of the core are substantially filled with the plastic material.

### TECHNICAL FIELD

This patent relates to a fusible spiral conductor for a fuse component with an electrically insulating or high resistance core around which at lest one fusible conductive wire is wound. This patent also relates to a method of manufacturing such a fusible spiral conductor.

### BACKGROUND

Fusible spiral conductors of the type referred to above have been used for a relatively long period of time in fuse components. For instance, a fusible conductive wire is wound around a core consisting of a plurality of glass fibers, whereby a predetermined winding density must be maintained in order to achieve desired properties. Such a pre-fabricated fusible spiral conductor is then cut to a predetermined length and introduced into, for instance, a ceramic tube and electrically connected and simultaneously mechanically fastened to the electrically conductive end caps, which are placed on the tube. The fusible spiral conductor is, for instance, soldered to the end caps for the purpose of electrical and mechanical connection.

It has transpired that the fuse elements, in which a fusible spiral conductor is used, have a poorer switching ability than fuse components, in which a conventional fusible conductive wire is used. This is due, in particular, to unsatisfactory quenching of the arc produced when breaking the circuit.

### SUMMARY

It is thus the desirable to provide a fuse component with a fusible spiral conductor which exhibits an improved circuit breaking performance. The device disclosed herein and recited in the claims addresses these desires and solves the short-comings of known devices by providing a fusible spiral conductor having numerous advantageous features, characteristic and properties.

The fusible spiral conductor for a fuse component with an electrically insulating or high resistance core, around which at least one fusible conductive wire is wound, is characterized in that a temperature-resistant plastic material is applied to the core such that at least the surface regions of the core exposed between the fusible conductive wire is covered by the plastic material and the interstices (that is to say gaps) formed between the wound fusible conductive wire and the surface of the core are substantially (i.e. at least to the extent that no capillary action is caused) filled with the plastic material.

The disclosed device is based at least on the recognition that the circuit breaking ability is impaired by residues of the flux used when soldering the fusible conductive wire, these residues deriving from the fact that the flux penetrates during the soldering process, as a result of capillary action, into gaps and interstices in the core or between the wound fusible conductive wire and the surface of the core.

The introduction, in accordance with one embodiment of the disclosed device, of a temperature-resistant plastic material constitutes a “sealing” of the gaps and interstices, which prevents penetration of the flux.

In accordance with one embodiment of the teaching disclosed herein, a fusible spiral conductor is produced by firstly impregnating a core with an unset liquid plastic material whereby the surface of the core is also coated with a layer of the plastic material, then the impregnated core is wound around with the fusible conductive wire before the setting of the plastic material and finally the plastic material is permitted to set so that a temperature-resistant plastic material is formed. The amount of the as yet unset liquid plastic material in the core can be so sized in this manufacturing method that when the winding process around the core is performed all the interstices and gaps between the fusible conductive wire and the core and within the core are closed but the outwardly directed surfaces of the fusible conductive wire remain free. This has the advantage that the fusible spiral conductor remains solderable without the plastic material firstly having to be removed.

One exemplary manufacturing method discloses that the fusible conductive wire is firstly wound onto the core. The fusible spiral conductor is then coated with an as yet unset liquid plastic material such that the plastic material can penetrate into interstices between the fusible conductive wire and the core and into any pores or gaps in the core which may be present. The plastic material then sets so that a temperature-resistant plastic material is formed. This alternative method offers the advantage that a conventional fusible spiral conductor can be used as the starting material.

In the fusible spiral conductor in accordance one embodiment of the disclosed device, the flux can no longer penetrate into the interstices between the fusible conductive wire and the core or into the core, whereby the switching ability is improved. Furthermore, the fusible conductive wire is fixed in position, after setting of the plastic material on the core, which enables higher winding densities of, for instance, above 60% to be achieved.

In another embodiment, the core consists of a plurality of glass and/or ceramic fibers, whereby the interstices between the individual fibers are also substantially filled by the plastic material. The cores comprising a plurality of parallel glass or ceramic fibers are compressed during the winding process so that—in the first alternative method of manufacture—after previous impregnation of the fibers with the plastic material a proportion of the plastic material is forced out of the core during the winding process and remains between the coils of wire. If a relatively high amount of excess liquid plastic material remains, the excess plastic material can subsequently be removed by mechanically wiping off the fusible spiral conductor.

In another embodiment, a silicone is used as the plastic material, which is applied in the liquid state and subsequently sets. The set silicone is temperature resistant. In an advantageous embodiment, one or more arc-quenching materials are mixed into the silicone, preferably a melamine powder. This additionally promotes the arc-quenching effect of the silicone coating. Advantageous and/or preferred embodiments of the invention are characterized in the dependent claims.

Additional features-and advantages of the disclosed device are described in, and will be apparent from, the following Detailed Description of the Invention and the figures.

### BRIEF DESCRIPTION OF THE FIGURES

FIG. 1 is a schematic view of an exemplary embodiment of the fusible spiral conductor in accordance with the invention;

FIG. 2 is a schematic sectional view of a fuse component with the fusible spiral conductor in accordance with the invention; and

FIG. 3 is a schematic sectional view of an alternative embodiment of a fuse component with the fusible spiral conductor in accordance with the invention.

### DETAILED DESCRIPTION

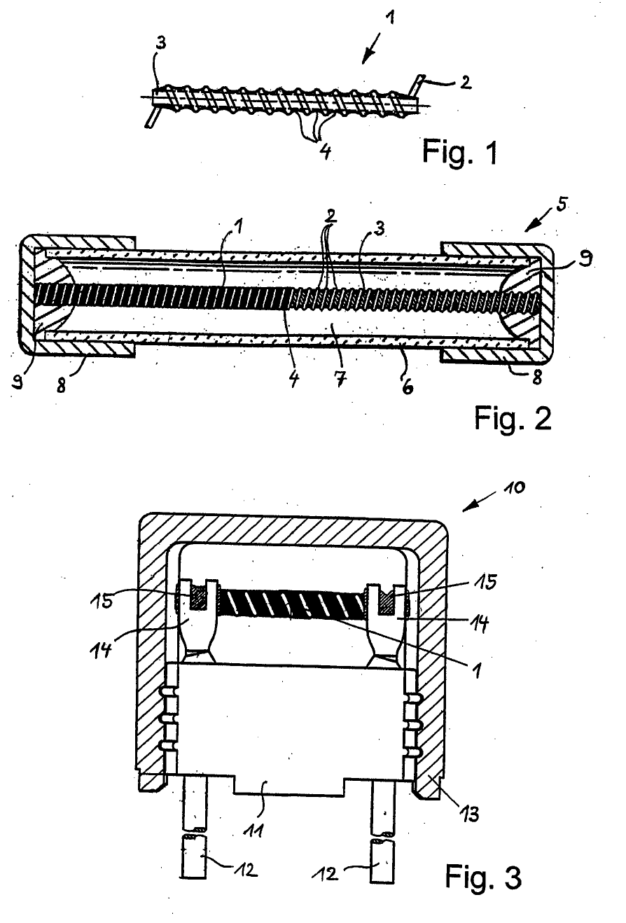

FIG. 1 illustrates a schematic view of a section of one embodiment of a fusible spiral conductor 1 in accordance with the teachings provided herein. A fusible conductive wire 2 is wound onto an insulating or high resistance core 3. The fusible conductive wire 2 is, for instance, a wire consisting of a silver-copper alloy core, provided with a tin layer, with a circular cross section and a diameter in the range of 0.05 mm to 0.5 mm. A large number of other alloys and metals are of course possible. The cross section also does not need to be circular and, for instance, a metal band can instead be wound. Thinner or thicker wires are also possible, depending on the desired characteristics. The core 3 could, for instance, consist of a rod, which is flexible to a smaller or greater degree, of an insulating material (e.g. glass, glass ceramic, plastic or ceramic) or high resistance material (e.g. semi conductors or high resistance metal conductors). In one embodiment, however, the core consists of a bundle of glass and/or ceramic fibers. The core may consist of fiberglass, i.e. a bundle of twisted or spun glass fibers. In the raw state, the glass fibers of the fiberglass engage one another relatively loosely so that many interstices are formed. When the fusible spiral wire 2 is wound around the fiber glass core 3, the fiber glass is compressed, i.e. the individual glass fibers are forced against one another.

In the manufacture of the fusible spiral conductor 1 in accordance with the one embodiment in which a core of fiber glass is used, the core 3 is impregnated before the winding process with a (still) liquid silicone plastic so that the interstices between the glass fibers fill up with the plastic material. Not all the interstices need to be filled of course; it is basically sufficient if the outer layers of the fiberglass fill up with the plastic so that the fiberglass is sealed so that no more liquid can get into the interstices which may possibly still be present. When the fusible conductive wire 2 is wound around the impregnated core 3, a proportion of the plastic material is squeezed out of the fiberglass and remains on the core 3 and fills the interstices (gaps) between the fusible conductive wire 2 and the core 3. If too much excess plastic material remains, this can be wiped off the fusible spiral conductor 1 whilst still in the liquid state. It is, however, also possible and preferred that the take up of the liquid plastic material into the raw core 3 is so sized that no wiping off is necessary after the winding process. FIG. 1 shows the remaining plastic material 4 between the individual windings of the fusible conductive wire 2. The plastic material subsequently hardens, the term hardening to be understood in the sense of cutting. The plastic material does not need to become hard or rigid. On the contrary, when using silicone, the set temperature-resistant plastic material preferably remains soft or elastic so that the fusible spiral conductor 1 remains flexible.

A silicone is preferably used as the plastic material, the silicone material preferably consisting of two components, which are mixed before application. Arc-quenching materials, particularly melamine powder, are preferably added to the silicone. For instance, ten parts silicone resin are mixed with four parts melamine powder.

FIG. 2 is a schematic view of a fuse component 5, in which the fusible spiral conductor in accordance with one embodiment is employed. The fusible spiral conductor 1 includes a core 3, onto which the fusible conductive wire 2 is wound and in which the interstices between the windings of the fusible conductive wire 2 are filled with the plastic material 4. In the schematic view of FIG. 2, the applied plastic material 4 is shown only on the left hand half of the fusible spiral conductor 1 for the sake of clarity. The fuse 5 includes an insulating tube 6 of glass, plastic or ceramic, in whose interior 7 the fusible spiral conductor 1 is accommodated. The tube 6 can have a round or rectangular cross section. The interior 7 can be filled with air, filled with gas, empty or filled with another material. Positioned (e.g. soldered or secured by adhesive) on the ends of the tube 6 are two end caps 8. The fusible conductor 1 is soldered to the base of the end caps 8, the solder being shown schematically in FIG. 2 by the solder regions 9. The solder joint can, however, be significantly smaller than is shown with the cross hatched regions 9 in FIG. 2. The cross hatched region 9 can, in this case, also represent a sealing material, which is introduced into the end caps.

If the fusible spiral conductor 1 is soldered onto the interior base of the end caps 8, a flux is of course also used in addition to the solder. The sealing, in accordance with one embodiment of the fusible conductor 1, by means of the plastic material 4 prevents molten or liquid portions of the flux migrating along the fusible spiral conductor by virtue of capillary action. Such flux residues, which are not removable, would constitute a source of carbon and, in the event of breaking the circuit (tripping) by the fusible conductor, form conductive bridges which promote reignition of the arc in the subsequent half waves.

FIG. 3 shows an alternative embodiment of a fuse element 10. Two contact pegs 12 are passed through a support 11. A protective cap 13 is positioned on the support 11. The ends of the connecting pegs 12 terminate in the interior between the support 11 and protective cap 13 in connecting lugs 14, secured to 15 which is a respective end of a fusible spiral conductor 1. The fusible spiral conductor 1 is secured to the connecting lugs 14 with a respective solder connection 15.

Numerous alternative embodiments are possible within the scope of the inventive concept. For instance, a fusible spiral conductor 1 can be used, in which one or more insulating fibers are wound around the core 3 parallel to the fusible conductive wire 2 and the adjacent windings of the fusible conductive wire 2 thus maintain a predetermining spacing from one another. The combination of such a further feature with the sealing accordance with the invention improves the circuit breaking ability and the reproducibility of the characteristics of the fusible spiral conductor.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A fusible spiral conductor for a fuse component (5) comprising:
an electrically insulating or high resistance core (3);
at least one fusible conductive wire (2) wound around the core; and
a temperature-resistant plastic material (4), the temperature-resistant plastic material applied to the core (3) and arranged such that at least the surface regions of the core exposed between the fusible conductive wire are covered by the plastic material and the interstices defined between the wound fusible conductive wire and the surface of the core are substantially filled with the plastic material.

2. The fusible spiral conductor as claimed in claim 1, wherein the core (3) includes a plurality of glass and/or ceramic fibers and the interstices between the glass and/or ceramic fibers are also substantially filled by the plastic material (4).

3. The fusible spiral conductor as claimed in claim 1, wherein the plastic material (4) surrounds the fusible spiral conductor (1) such that the outer surfaces of the fusible conductive wire (2) are also covered with the plastic material.

4. The fusible spiral conductor as claimed in one of claims 1, wherein one or more insulating fibers are wound around the core parallel to the fusible conductive wire which maintain adjacent windings of the fusible conductive wire at a predetermined spacing from one another.

5. The fusible spiral conductor as claimed in one of claims 1, wherein the plastic material is a silicone material.

6. The fusible spiral conductor as claimed in claim 5, wherein the silicone material includes one or more arc-quenching materials.

7. The fusible spiral conductor as claimed in claim 6, wherein the arc-quenching material is a melamine powder.

8. A method of manufacturing a fusible spiral conductor in which a fusible conductive wire is wound around an insulating or high resistance core, the method comprising:
a) impregnating the core with an unset liquid plastic material, and coating the surface of the core with a layer of the plastic material.
b) winding the fusible conductive wire around the impregnated core before the setting of the plastic material, and
c) permitting the plastic material to set so that a temperature-resistant plastic material is formed.

9. The method as claimed in claim 8, wherein the core is impregnated with an amount of the liquid plastic material which results, with compression of the core accompanying the winding of the fusible conductive wire, in excess plastic material being squeezed out.

10. The method as claimed in claim 9, wherein after the winding of the fusible conductive wire, excess plastic material is removed by wiping off.

11. A method of manufacturing a fusible spiral conductor, in which a fusible conductive wire is wound around an insulating or high resistance core, the method comprising:
a) winding the fusible conductive wire onto the core
b) coating the fusible spiral conductor with an as-yet-unset liquid plastic material such that the plastic material can penetrate into the interstices between the fusible conductive wire and the core and into pores or gaps in the core which may be present, and
c) permitting the plastic material to set so that a temperature-resistant plastic material is formed.

12. A method as claimed in claim 11, wherein after coating, excess plastic material is wiped off from the fusible spiral conductor.

13. A method as claimed in one of claims 8, wherein a settable silicone resin is used as the liquid plastic material.
